(19) United States
(12) Patent Application Publication
(10) Pub. No.: US 2015/0016625 A1
(43) Pub. Date: Jan. 15, 2015

(54) AUDIO PROCESSING DEVICE

(71) Applicants: Hiroaki Hosoya, Yamagata (JP); Takashi Kaneko, Yamagata (JP)

(72) Inventors: Hiroaki Hosoya, Yamagata (JP); Takashi Kaneko, Yamagata (JP)

(73) Assignees: TOHOKU PIONEER CORPORATION, Yamagata (JP); PIONEER CORPORATION, Kanagawa (JP)

(21) Appl. No.: 14/375,993

(22) PCT Filed: Feb. 1, 2012
(86) PCT No.: PCT/JP2012/052323

§ 371 Date: Jul. 31, 2014

(51) Int. Cl. H04R 3/04; H04R 1/10

(52) U.S. Cl. CPC H04R 3/04; H04R 1/1033
USPC 381/74; 381/384

(57) ABSTRACT

An audio processing device includes an earphone with a microphone, a cord, and a cord holding part, and a main unit connected to the cord. The main unit processes an audio signal sent from the microphone, and the earphone includes a housing that stores the microphone. The housing also includes a microphone hole part, and the cord holding part faces the microphone hole part.

### FIELD OF THE INVENTION

The present invention relates to an audio processing device.

### BACKGROUND OF THE INVENTION

There is known an electronic device equipped with a hearing aid function capable of taking in an external sound, amplifying an audio signal thereof, and outputting an amplified audio signal to a speaker unit of an earphone (see the patent document 1 below). This type of electronic device is configured such that a pair of earphones is connected to a main body; a microphone and a speaker unit are incorporated in the earphones; and the main body has an amplifier for amplifying an electric signal from the microphone incorporated in the earphone, and an operation unit such as a switch for variably adjusting a sound volume balance of a speaker.

### RELATED ART DOCUMENTS

### Patent Document

Patent document 1: Japanese utility model application publication 04-061996

### SUMMARY OF THE INVENTION

### Problem To Be Solved by the Invention

Especially in the case where a user makes a telephone call with the earphone attached to the ear in the above described electronic device, the speaker unit in a receiver is brought close to the microphone in an earphone housing when the speaker unit of the receiver is made to approach the ear, and thus sounds emitted from the speaker unit of the receiver can be amplified in a natural use of the receiver and emitted from the speaker unit of the earphone.

In this way, a user may move a speaker unit of a receiver close to the microphone of an earphone to better hear the sounds emitted from the speaker unit of the receiver. In this kind of situation, the receiver and so forth may be brought into contact with the microphone of the earphone and generates a contact sound, which may be amplified by the main unit of a hearing aid and emitted from the speaker unit of the earphone. Such a contact sound, when amplified and emitted from the speaker unit, not only makes a user uncomfortable, but also makes it difficult for the user to hear a conversation through the speaker unit, and thereby could cause a problem that the user fails to catch an important conversation and so forth.

One of objects according to the present invention is to address such a problem. That is, the object of the present invention is to make it possible to achieve audio amplification without making a user feel uncomfortable during telephone conversation using an audio processing device having a microphone stored in the housing of an earphone, and to therefore eliminate a problem that a contact sound could make it difficult for the user to hear a conversation through the receiver.

### Means for Solving the Problem

To achieve such an object, the audio processing device according to the present invention is provided with at least the following configuration:

An audio processing device comprising: an earphone including a speaker unit and a microphone; and a main unit electrically connected to the earphone, wherein the main unit processes an audio signal collected by the microphone and outputs the processed signal to the speaker unit; the earphone including a housing storing the speaker unit and the microphone and a cord for electrically connecting the main unit with the earphone; the housing including a first housing part storing the speaker unit and a second housing part storing the microphone; the cord is pulled out from the housing through a cord holding part of the housing; the second housing part extends along the code holding part; and the code holding part is arranged at a position opposite a microphone hole part of the second housing part.

### BRIEF DESCRIPTION OF THE DRAWINGS

FIG. 1 is a view illustrating an entire configuration of an audio processing device according to an embodiment of the present invention.

FIG. 2 is a view illustrating an earphone structure of the audio processing device according to an embodiment of the present invention. FIG. 2(a) is a view illustrating an external appearance, and FIG. 2(b) is a cross-sectional view illustrating the internal structure.

FIG. 3 is a view illustrating a circuit configuration of the audio processing device according to an embodiment of the present invention.

FIG. 4 is a view illustrating the aspects of mode changeover in accordance with use environment for the audio processing device according to the embodiment of the present invention, which illustrates the characteristics of a plurality of different band pass filters.

FIG. 5 is a view illustrating frequency characteristics to the output sound pressure from the speaker unit of the audio processing device according to the embodiment of the present invention.

FIG. 6 is a view illustrating frequency characteristics to the output sound pressure from the speaker unit of the audio processing device according to the embodiment of the present invention.

FIG. 7 is a view illustrating frequency characteristics to the output sound pressure from the speaker unit of the audio processing device according to the embodiment of the present invention.

FIG. 8 is a view illustrating frequency characteristics to the output sound pressure from the speaker unit of the audio processing device according to the embodiment of the present invention.

FIG. 9 is a view illustrating frequency characteristics to the output sound pressure from the speaker unit of the audio processing device according to the embodiment of the present invention.

FIG. 10 is a view illustrating the configuration of the connection terminal of the earphone and the terminal to be connected of the main unit.

FIG. 11 is a view illustrating a specific example of the connection terminal of the earphone and the attached earphone.

FIG. 12 is a view illustrating the main unit of the audio processing device according to an embodiment of the present invention.

### PREFERRED EMBODIMENTS FOR PRACTICING THE INVENTION

Hereinafter, an embodiment according to the present invention is described with reference to the drawings. Although the embodiment according to the present invention includes the embodiment shown in the drawings, the invention is not particularly limited to the embodiment.

Entire Configuration

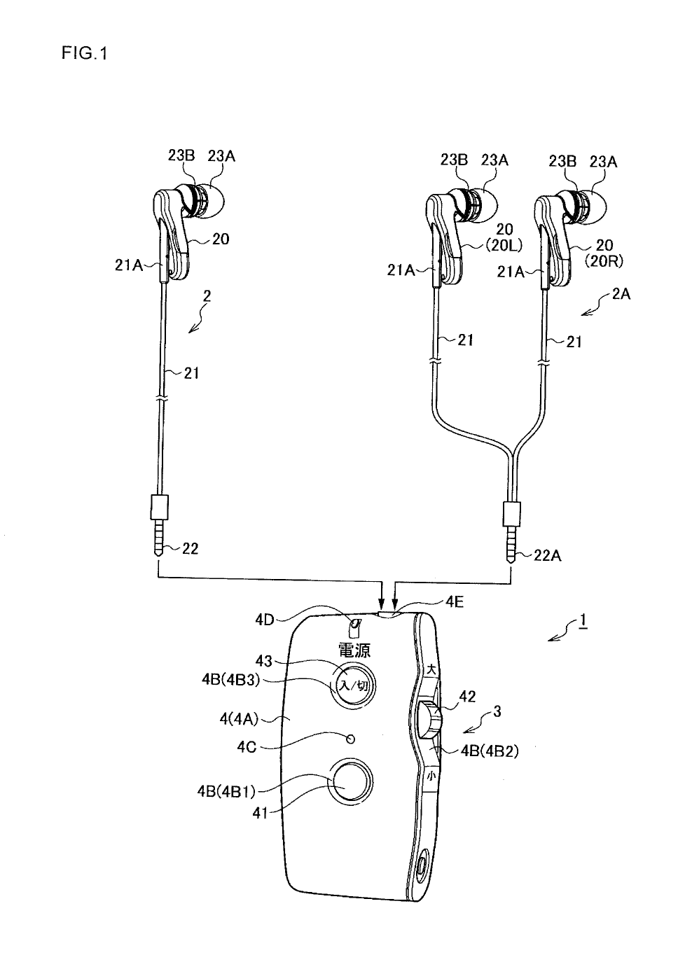

FIG. 1 is a view illustrating an entire configuration of an audio processing device according to an embodiment of the present invention. An audio processing device 1 includes an earphone 2 and a main unit 3. The earphone 2 includes a housing 20 and a cord 21, and the cord 21 is pulled out from the housing 20 through a cord holding part 21A. A connection terminal 22 is provided on the end of the cord 21. The housing 20 of the earphone 2 is provided with an auricle connect part 23A for hermetically holding the housing 20 in the ear of a user, and an auricle contact part 23B for bringing the housing 20 into contact with the inside of the auricle, which are attached to the housing.

The earphone 2 includes a speaker unit and a microphone inside the housing 20 as described later. The earphone 2 includes a single housing 20, and one speaker unit and one non-directional microphone are stored in the single housing 20.

A single cord 21 of the earphone 2 contains a signal line which electrically connects the speaker unit, the main unit 3, and the microphone. For example, a conductive wire is listed as the signal line. The cord 21 is constituted of the conductive wire and an insulation member (resin member) insulating the conductive wire from outside. The insulation member has an elastic property to facilitate the user's use. The cord holding part 21A is constituted of a member having bending rigidity (resin member) which covers the cord 21. The member having bending rigidity has greater bending rigidity than that of insulation member of the cord 21. While the user is using the earphone 2, although the cord 21 may vibrate relative to the ear of the user, the cord holding part 21A having bending rigidity greater than that of the cord 21 maintains a prescribed gap with respect to the microphone hole part 27. That is, the cord holding part 21A with relatively high rigidity may suppress contact between the cord holding part 21A and the microphone hole part 27.

The main unit 3 has an audio signal processing circuit which is electrically connected to the earphone 2 and processes (including amplification or attenuation) the audio signal collected by the microphone to output the processed signal to the speaker unit. The main unit 3 includes a housing 4 (main unit housing) storing the audio signal processing circuit. The housing 4 includes a mode changeover switch 41 (changeover switch) for changing over the modes for use environment described later, a sound volume adjustment wheel 42, and a power source switch 43 for turning a power source on or off. The changeover switch 41, the sound volume adjustment wheel 42, and the power source switch 43 are arranged in recesses 4B (4B1, 4B2, 4B3) that are provided on the housing side face 4A of the main unit 3, and thus the changeover switch 41, the sound volume adjustment wheel 42, and the power source switch 43 are arranged to not project above the housing side face 4A.

The main unit 3 includes a first light source 4C and a second light source 4D on the housing 4. A user selects a mode using the mode changeover switch 41 in accordance with the use environment of user himself or herself from among modes corresponding to a plurality of different band pass filters. At this moment, the first light source 4C emits light emission colors different from each other corresponding to the modes changed over by the mode changeover switch 41. Meanwhile, the user turns the power source of the main unit 3 on or off by pressing the power source switch 43. At this moment, the second light source 4D is put on or put off in response to the turn-on or turn-off of the power source for the main unit 3.

The main unit 3 includes a terminal to be connected 4E to which a connection terminal 22 of the earphone 2 can be connected. The terminal to be connected 4E is configured to allow an attached earphone 2A to be connected thereto instead of the earphone 2. The attached earphone 2A includes pairs of the housings 20, cords 21 and so forth, which includes a housing 20R attached to the right ear of the user, and a housing 20L attached to the left ear of the user. The connection terminal 22A of the attached earphone 2A is connected to the terminal to be connected 4E of the main unit 3 so that the speaker units and the microphones in the housings 20R, 20L are electrically connected to the main unit 3.

In the audio processing device 1 having such a configuration, the earphone 2 comprises: a single housing 20 in which one speaker unit and one microphone are stored; a single cord 21 which contains a signal line for electrically connecting the speaker unit, the main unit 3, and the microphone; and a connection terminal 22 which is provided at the end of the cord 21 and connects the signal line with the main unit 3. The earphone 2 is connected to the main unit 3 so that a user can use the audio processing device 1 by attaching the housing 20 to either a left or right ear.

In such a situation, the user can use the audio processing device 1 with one ear free. Thereby, an uncomfortable cooped-up feeling felt by a user when both ears are plugged up with earphones may be eliminated. That is, the user can hear sounds processed by the audio processing (including amplification or attenuation) device 1 with one ear to which the earphone 2 is attached while hearing the environmental sound with the other opened ear, and thus can hear the processed (including amplification or attenuation) sounds with the same feeling as in the case when not using the audio processing device 1.

A non-directional microphone is stored in a single housing 20. Thereby, even when the single housing 20 of the earphone 2 is attached to one ear, the non-directional microphone collects ambient sounds, and processes (including amplification or attenuation) the sounds to output to the speaker unit in the single housing 20.

The changeover switch 41, the sound volume adjustment wheel 42, and the power source switch 43 in the main unit 3 are arranged to not project above the housing side face 4A of the main unit 3. Specifically, the changeover switch 41, the sound volume adjustment wheel 42, and the power source switch 43 are arranged near the main unit 3 with the housing side face 4A as a boundary face. Therefore, the changeover switch 41, the sound volume adjustment wheel 42, and the power source switch 43 making an approach to the boundary face are arranged near the main unit 3 with reference to the boundary face. As such, even when the main unit 3 is used inside a pocket of clothes and so forth, the misoperation of the changeover switch 41, the sound volume adjustment wheel 42, and the power source switch 43 can be avoided.

Earphone Structure

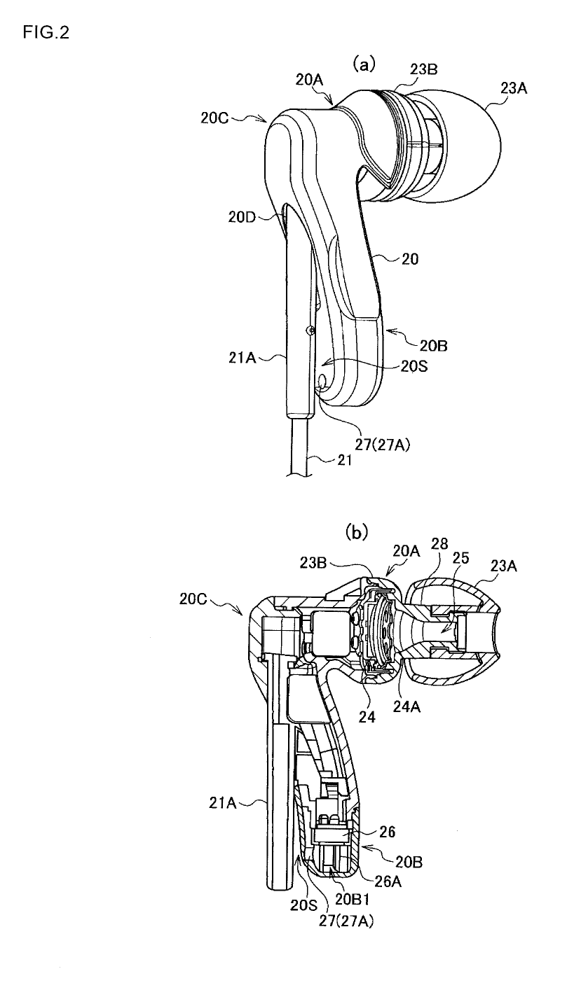

FIG. 2 is a view illustrating an earphone structure of the audio processing device according to an embodiment of the present invention. FIG. 2(a) is a view illustrating an external appearance, and FIG. 2(b) is a cross-sectional view illustrating the internal structure.

A speaker unit 24 and a microphone 26 are stored in the housing 20 of the earphone 2. The housing 20 includes a first housing part 20A storing the speaker unit 24, and a second housing part 20B storing the microphone 26. The first housing part 20A includes an acoustic emitting hole part 25 for emitting sound wave from the speaker unit 24. The sound wave is emitted from an acoustic emitting face of the speaker unit 24. The second housing part 20B is provided with an internal space 20B1 on the side of an acoustic passive face 26A of the microphone 26. The internal space 20B1 of the second housing part 20B communicates with outside through a microphone hole part 27.

The earphone 2 includes a leading sound tube 28 arranged on the side of the acoustic emitting hole part 25 of the housing 20. The leading sound tube 28 extends along the axis (central axis) of the acoustic emitting hole part 25. The leading sound tube 28 has an auricle connect part 23A attached thereto. The auricle connect part 23A is provided around the leading sound tube 28. Additionally, an auricle contact part 23B is provided on the side face of the housing near the auricle connect part 23A. Sealability for the ear using he earphone can be improved with the auricle contact part 23B. The speaker unit 24 has a well-known structure, and includes a vibration unit having a voice coil and a diaphragm, and a magnetic circuit. The diaphragm has an acoustic emitting face 24A. Additionally, an armature type (electromagnetic type) speaker unit may be adopted instead of the above described speaker unit 24.

The housing 20 includes a curved part 20C curved from the first housing part 20A toward the second housing part 20B. The first housing part 20A extends along the axis (central axis) of the acoustic emitting hole part 25. The second housing part 20B extends along a direction different from that of the first housing part 20A from the curved part 20C. The extending direction of the first housing part 20A intersects with the extending direction of the second housing part 20B.

The cord 21 is pulled out from a cord pull-out hole part 20D provided on the housing 20. The cord 21 is pulled out from the housing 20 through the cord holding part 21A of the housing 20. A portion of the cord holding part 21A near one end of both ends of the cord holding part 21A is supported inside the housing 20, and another portion of the cord holding part 21A near the other end projects outside the housing 20 from the cord pull-out hole part 20D.

The second housing part 20B extends from the curved part 20C toward the cord holding part 21A. Further, the second housing part 20B extends along the projecting direction of the cord holding part 21A. The second housing part 20B extends along the cord holding part 21A. Further the second housing part 20B includes a microphone hole part 27. The cord holding part 21A is arranged at the position opposite the microphone hole part 27 of the second housing part 20B. In the example shown in the drawing, the cord holding part 21A is arranged opposite the opening 27 of the microphone hole part 27. The cord holding part 21A has bending rigidity greater than that of the cord 21. A gap 20S is provided between the side face of the cord holding part 21A and the microphone hole part 27. Particularly, the gap 20S is provided between a side face of the cord holding part 21A and the microphone hole part 27. In the example shown in the drawing, the cord holding part 21A extends in a linear shape, and the second housing part 20B extends in a curved shape. Thereby, the gap 20S is formed between the cord holding part 21A and the second housing part 20B.

One end of the cord 21 of both ends thereof is arranged in the housing 20. The cord 21 is arranged on an opposite side of the acoustic emitting hole part 25 of the housing 20. The axis (central axis) of the acoustic passive face 26A of the microphone 26 intersects with the axis (central axis) of the acoustic emitting hole part 25. The microphone hole part 27 is opened toward the cord 21 or the cord holding part 21A.

The audio processing device 1 including the earphone 2 having such a configuration is configured such that the cord holding part 21A is arranged opposite the microphone hole part 27, and thus can prevent the hand and clothes of the user from coming in contact with the microphone hole part 27. Therefore, the microphone 26 is prevented from catching a contact sound which may make a user feel uncomfortable.

Particularly, when a user want to hear sounds emitted from a telephone receiver (alternatively the main unit of a mobile phone) by bringing the telephone receiver close to the housing 20 to process (including amplification or attenuation) the sounds, the cord holding part 21A provided on the earphone 2 can prevent the receiver from coming in contact with the microphone hole part 27. Since the receiver is prevented from coming in contact with the microphone hole part 27, the contact sound associated with the contact between the microphone hole part 27 and the receiver is prevented from being processed (including amplification or attenuation) and emitted from the speaker unit 24 of the earphone 2. Further, since the receiver is prevented from coming in contact with the microphone hole part 27, the processed (including amplification or attenuation) contact sound is prevented from making the user feel uncomfortable. Also, it is possible to eliminate a problem that the contact sound associated with the contact between the receiver and microphone hole part 27 makes it difficult for the user to hear sounds emitted from the speaker unit, and thereby making the user fail to catch an important conversation and so forth.

One end of the cord holding part 21A (an end near the housing 20) is supported by the housing 20. The cord holding part 21A itself has bending rigidity. Further, the gap 20S is provided between the cord holding part 21A and the housing 20. As such, even when the cord holding part 21A is pushed by the receiver and so forth, the cord holding part 21A itself or the cord 21 is prevented from coming in contact with the microphone hole part 27.

Further, the axis of the acoustic passive face 26A of the microphone 26 stored in the earphone 2 in the audio processing device 1 according to an embodiment of the present invention intersects with the axis of the acoustic emitting face of the speaker unit 24. Further, the axis of the acoustic passive face 26A of the microphone 26 intersects with the axis of the acoustic emitting hole part 25 along the axis of the acoustic emitting face of the speaker unit 24 in this embodiment. The meaning of “intersects” includes that the axes of the acoustic passive face 26A and the acoustic emitting face intersect with each other in a three-dimensional space, and that, of the axes of the acoustic passive face 26A and the acoustic emitting face, one axis, when projected, intersects with a two-dimensional plane including the other axis. The microphone hole part 27 provided on the housing 20 is opened toward the cord 21 or the cord holding part 21A. As such, it is possible to suppress the occurrence of howling (oscillation phenomenon) generated by the vibration which is caused by driving the speaker unit 24 and transmitted to the microphone 26 through the housing 20. Further, the microphone hole part 27 is opened toward the cord 21 or the cord holding part 21A. As such, the voice emission direction of the telephone receiver can be directed directly to the microphone hole part 27. Additionally, sounds emitted from the receiver can be reliably collected by the microphone 26. The acoustic wave taken in the microphone hole part 27 passes through an internal space 20B1 to vibrate the acoustic passive face 26A so that the microphone 26 can collect sounds.

The housing 20 includes the first housing part 20A storing the speaker unit 24, and the second housing part 20B storing the microphone 26. The first housing part 20A and the second housing part 20B extend in the mutually different directions. As such, it is possible to separate the speaker unit 24 and the microphone 26 away from each other. The above described howling can be avoided by providing a prescribed distance between the speaker unit 24 and the microphone 26. Additionally, the second housing part 20B is extended along the cord 21. As such, when a user wears the earphone 2, the microphone is arranged below the user's ear. Thereby, when a user makes conversation using a mobile phone (for example, smartphone), the user can converse at a moderate volume of voice through the mobile phone while hearing the voice the user himself or herself utters by collecting the voice of the user using the microphone of the earphone.

Circuit Configuration

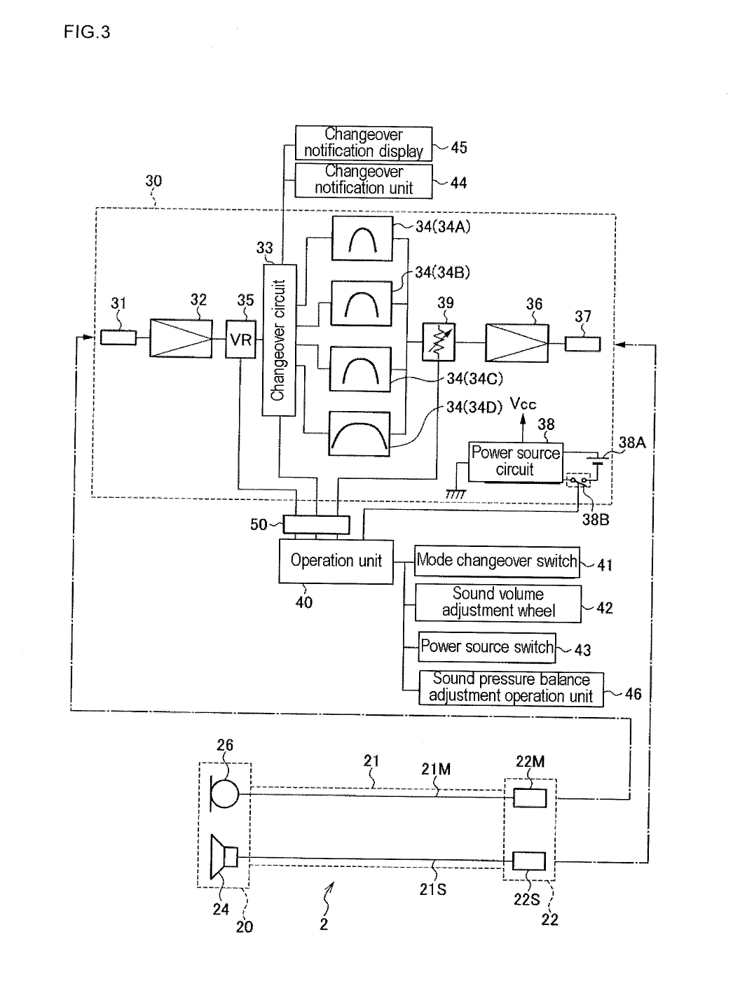

FIG. 3 is a view illustrating a circuit configuration of the audio processing device according to an embodiment of the present invention. The main unit 3 includes an audio signal processing circuit 30 which processes (including amplification or attenuation) the audio signal collected by the microphone 26 and output the processed signal to the speaker unit 24. The audio signal processing circuit 30 includes an audio signal input unit 31 and an audio signal output unit 37, and the connection terminal 22 of an earphone 2 is connected to the terminal to be connected 4E of the main unit 3 so that an audio signal sent from a microphone 26 to a microphone terminal 22M through a signal line 21M is input into an audio signal input unit 31, and a processed (including amplification or attenuation) audio signal is sent to a speaker unit 24 through a speaker terminal 22S and a signal line 21S.

For example, the audio signal processing circuit 30 for processing (including amplification or attenuation) an audio signal output from an audio signal input unit 31 includes a preamplifier 32, a changeover circuit 33, a band pass filter 34, a sound volume control unit (slide volume) 35, a power amplifier 36, and an audio signal output unit 37. Further, the audio signal processing circuit 30 includes a power source circuit 38 for supplying the audio signal processing circuit 30 with a drive voltage Vcc.

A battery (cell) 38A is connected to the power source circuit 38, and a power source breaker 38B is provided between the battery (cell) 38A and the power source circuit 38.

The audio signal processing circuit 30 is operated by an operation signal from an operation unit 40. The operation unit 40 is provided to output an operation signal acquired from the above described mode changeover switch 41, sound volume adjustment wheel 42, power source switch 43, and sound pressure balance adjustment operation unit 46. Additionally, the main unit 3 instead of the audio signal processing circuit 30 may include the power source circuit

The operation unit 40 sends a changeover operation signal generated by the mode changeover switch 41 to the changeover circuit 33, sends an adjustment operation signal generated by the sound volume adjustment wheel 42 to the sound volume adjustment unit 35, and sends an on-off operation signal generated by the power source switch 43 to the power source breaker 38B. Additionally, the operation unit 40 sends an adjustment signal generated by the sound pressure balance adjustment operation unit 46 to a sound pressure balance adjustment unit 39.

When the attached earphone 2A is connected to the main unit 3, the sound pressure balance adjustment unit 39 has a function of adjusting balance between the right and left sound pressures in a right ear speaker unit 24(R) and left ear speaker unit 24(L) included in the attached earphone 2A which is described later.

A control tool (for example: microcomputer) 50 can determine whether the main unit 3 is connected with the earphone 2 or with the attached earphone 2A as described later. When detecting that the earphone 2 is connected to the main unit 3, the control tool sends a signal to the sound pressure balance adjustment unit 39 to turn the adjustment function of the sound pressure balance adjustment unit 39 off (suspension).

The changeover circuit 33 selectively switches a plurality of different band pass filters (34A-34D) in response to a changeover operation signal input from the mode changeover switch

The sound volume adjustment unit 35 variably controls the sound volume of an audio signal using an adjustment signal input from the sound volume adjustment wheel 42. The power source breaker 38B makes or breaks connection between the battery 38A and the power source circuit 38 using an On-off operation signal input from the power source switch 43.

The plurality of different band pass filters 34 may be incorporated in the audio signal processing circuit 30 in a changeable state or a fixed state where either selected one or multiple band pass filters are fixed. Here, “fixed state” means a state where the characteristics of the band pass filters 34 corresponding to each mode cannot be changed after the band pass filters 34 are incorporated into the audio signal processing circuit 30.

Mode Changeover in Accordance with Use Environment (Characteristics of Band Pass Filter)

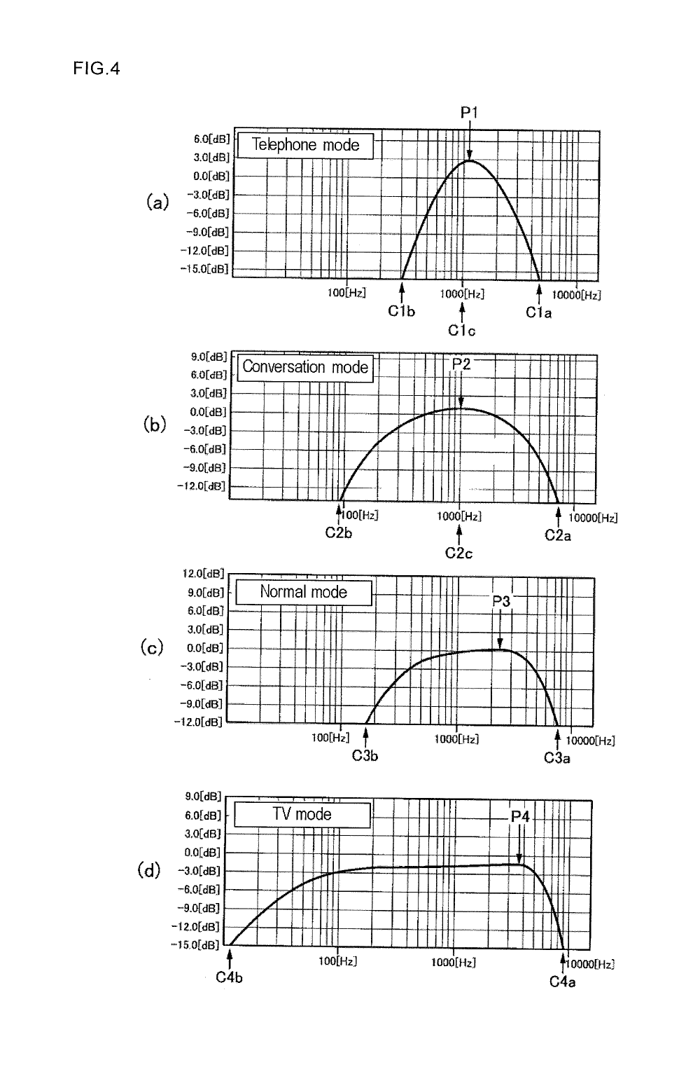

FIG. 4 is a view illustrating the aspects of mode changeover in accordance with use environment for the audio processing device according to the embodiment of the present invention, which illustrates the characteristics of a plurality of different band pass filters. The audio processing device 1 according to an embodiment of the present invention can selectively change a mode to an operation mode suitable for each use environment corresponding to the difference in use environment.

In order to practice the mode changeover, the band pass filter 34 of the audio signal processing circuit 30 includes a plurality of different band pass filters (34A, 34B, 34C, 34D) so that the changeover circuit 33 may selectively change a band pass filter to any one the band pass filters. The plurality of different band pass filters 34A, 34B, 34C, 34D can be set to be used, for example, in a telephone mode, a conversation mode, a normal mode, and a TV mode.

A first band pass filter 34A (for use in telephone mode) which is one of the plurality of different band pass filters 34A to 34D has a characteristic, for example, shown in FIG. 4(a). The first band pass filter 34A has a characteristic which selectively allow sounds emitted from the receiver of a telephone (within the frequency band from approximately 300 Hz to approximately 3400 Hz) to pass through, and thus is suited for the use environment where the sound emitted from the receiver is processed (including amplification or attenuation) and heard with the speaker unit of the receiver brought close to the microphone hole part 27 of the earphone 2.

The first band pass filter 34A has a low pass filter having a cutoff frequency C1a (approximately 2500 Hz shown in the drawing) of approximately 2000 Hz to approximately 3000 Hz, a high pass filter having a cutoff frequency C1b (approximately 700 Hz shown in the drawing) of approximately 300 Hz to approximately 800 Hz, and an equalizer having a central frequency C1c (approximately 1000 Hz shown in the drawing) of approximately 700 Hz to approximately 1200 Hz.

The first band pass filter 34A has a filter characteristic that the interval between the cutoff frequencies C1a and C1b is relatively narrow. Additionally, the frequency P1 at which an amplification factor is maximized is located between approximately 1000 Hz and approximately 2000 Hz.

When a filter is switched to the first band pass filter 34A having such a filter characteristic, the sound emitted from the receiver of a telephone may be selected and processed (including amplification or attenuation). The sound outside the frequency band selected by the first band pass filter 34A such as an environmental sound and so forth is not processed (including amplification or attenuation), and thus the sound emitted from the receiver can be clearly heard even when noises are generated around a user. Additionally, the frequency band of the sound emitted from the receiver of a telephone is 300 Hz to 3400 Hz.

A second band pass filter 34B (for use in conversation mode) which is one of the plurality of different band pass filters 34A-34D has a characteristic, for example, shown in FIG. 4(b). The second band pass filter 34B has a low pass filter having a cutoff frequency C2a (approximately 4900 Hz shown in the drawing) higher than a cutoff frequency C1a (approximately 2500 Hz shown in the drawing) in a low pass filter of the first band pass filter 34A, a high pass filter having a cutoff frequency C2b (approximately 150 Hz shown in the drawing) lower than a cutoff frequency C1b (approximately 700 Hz shown in the drawing) in a high pass filter of the first band pass filter 34A, and an equalizer having a central frequency C2c (approximately 1000 Hz shown in the drawing) of approximately 700 Hz to approximately 1200 Hz. The frequency P2 at which an amplification factor is maximized is located between approximately 900 Hz and approximately 2000 Hz (approximately 1000 Hz shown in the drawing). Further the second band pass filter 34B has a characteristic that a maximum amplification factor thereof is smaller than a maximum amplification factor of the first band pass filter 34A.

When a filter is switched to the second band pass filter 34B having such a filter characteristic, the conversation sound may be effectively processed (including amplification or attenuation) in the use environment where there is a lot of conversation. Particularly, when used in a meeting room, conversational sounds are effectively processed (including amplification or attenuation) and the noises outside the frequency band selected by the second band pass filter 34B are not processed (including amplification or attenuation), and thus the conversational sounds may be heard clearly even when noises are generated around a user. Additionally, the second band pass filter has the lowest frequency (the lowest frequency in the smallest amplification factor) lower than the lowest frequency of the third band pass filter described later, and has a characteristic that allow the sounds within the relatively low frequency band to pass through compared to the third band pass filter.

A third band pass filter 34C (for use in normal mode) which is one of the plurality of different band pass filters 34A-34D has a characteristic, for example, shown in FIG. 4(c). The third band pass filter 34C has a low pass filter having a cutoff frequency C3a (approximately 4400 Hz shown in the drawing) lower than a cutoff frequency C2a (approximately 4900 Hz shown in the drawing) in a low pass filter of the second band pass filter 34B, and a high pass filter having a cutoff frequency C3b (approximately 300 Hz shown in the drawing) higher than a cutoff frequency C2b (approximately 150 Hz shown in the drawing) in a high pass filter of the second band pass filter 34B. Further, the frequency P3 at which an amplification factor is maximized is located between approximately 2000 Hz and approximately 3000 Hz. Further the third band pass filter 34C has a characteristic that a maximum amplification factor thereof is smaller than a maximum amplification factor of the second band pass filter 34B.

When a filter is switched to the third band pass filter 34C having such a filter characteristic, the necessary sounds or voices may be effectively processed (including amplification or attenuation) in the normal use environment where there is a lot of human voices, instrumental sounds and so forth.

A fourth band pass filter 34D (for use in TV mode) which is one of the plurality of different band pass filters 34A-34D has a characteristic, for example, shown in FIG. 4(d). The fourth band pass filter 34D has a low pass filter having a cutoff frequency C4a (approximately 5300 Hz shown in the drawing) higher than a cutoff frequency C3a (approximately 4400 Hz shown in the drawing) in a low pass filter of the third band pass filter 34C, and a high pass filter having a cutoff frequency C4b (approximately 49 Hz shown in the drawing) lower than a cutoff frequency C3b (approximately 300 Hz shown in the drawing) in a high pass filter of the third band pass filter 34C. Further, the frequency P4 at which an amplification factor is maximized is located between approximately 3000 Hz and approximately 4000 Hz.

Further the fourth band pass filter 34D has a characteristic that a maximum amplification factor thereof is smaller than a maximum amplification factor of the third band pass filter 34C.

When a filter is switched to the fourth band pass filter 34D having such a filter characteristic, necessary sounds may be effectively processed (including amplification or attenuation) in the use environment having a wide frequency range. Particularly, the sounds of TV having a wide frequency range of approximately 5 Hz to approximately 20 kHz, the mode where a filter is switched to the fourth band pass filter 34D is suitable for watching TV. Further, by matching the range of cutoff frequencies C3b to C3a to the range of frequencies approximately 50 Hz to approximately 15 kHz that is the frequency range of music, the band pass filter can be made more suitable for listening to music.

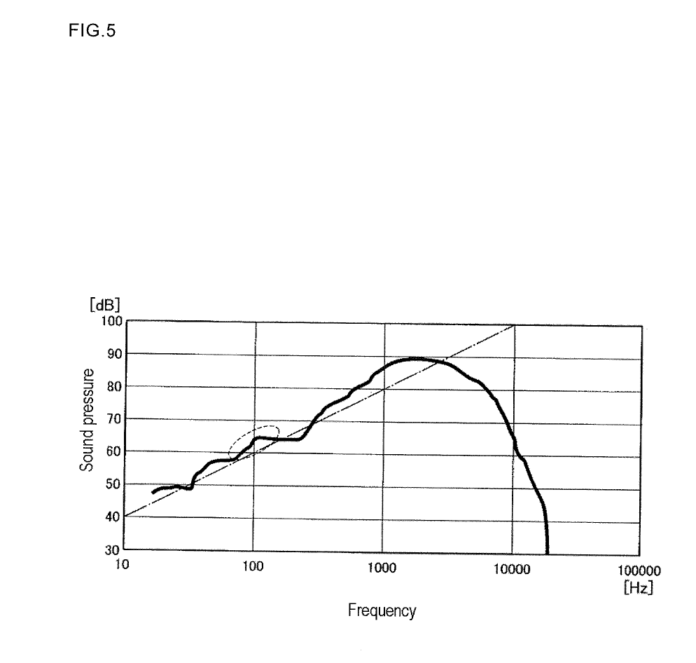

FIGS. 5 to 9 are views illustrating frequency characteristics to the output sound pressure from the speaker unit of the audio processing device according to the embodiment of the present invention. FIGS. 5 to 8 illustrate curves representing frequency characteristics of output sound pressure, and reference lines connecting a point (10000 Hz, 100 dB) and another point (10 Hz, 40 dB) shown by one-dot broken lines. Here, the range where the sound pressure is higher than the reference line is defined as a “convex roll” which is surrounded by a broken line. The feature of the frequency characteristics of output sound pressure when employing each band pass filter is represented by the size of the rolls. As shown in FIGS. 5-8, in the frequency characteristics to the output sound pressure from a speaker unit, the above described rolls are varied with the first to fourth band pass filters.

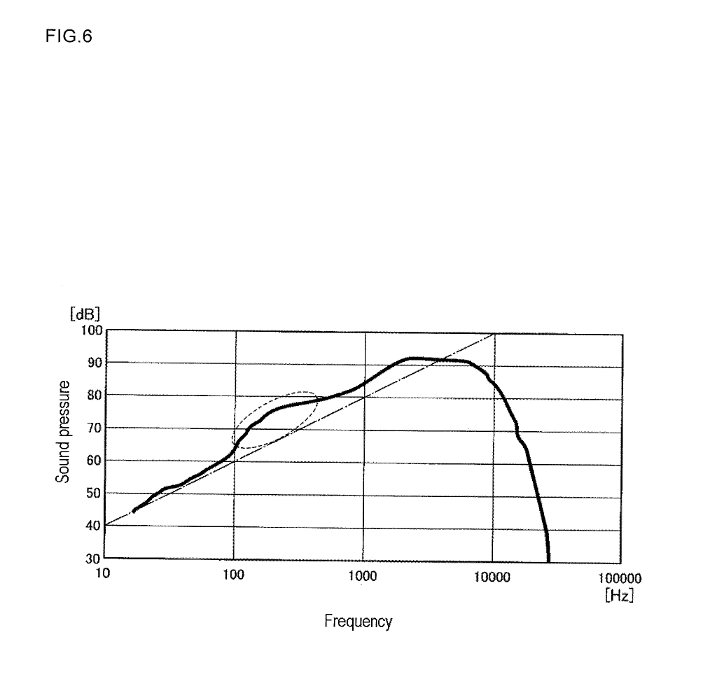

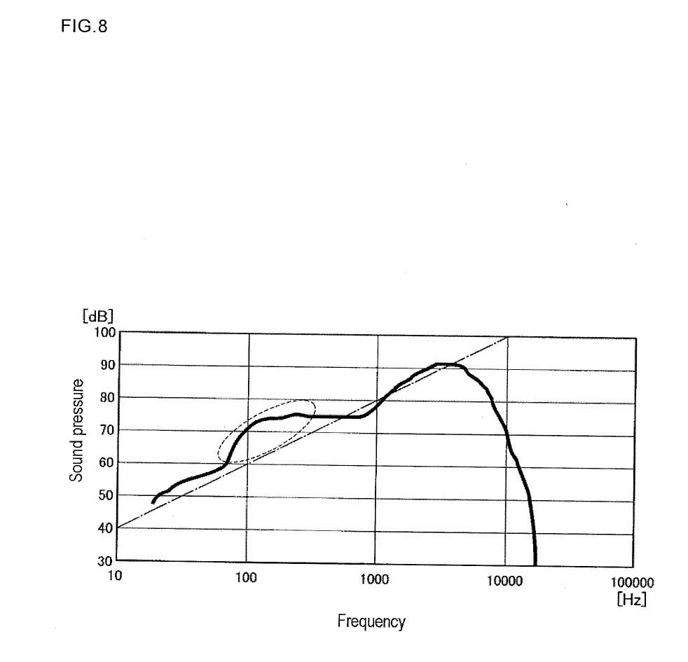

FIG. 5 shows frequency characteristics of output sound pressure when the mode corresponding to the first band pass filter is selected. In the example shown in the drawing, the sound pressure gradually increases from approximately 20 Hz to approximately 130 Hz. The frequency characteristics of output sound pressure is flat in the frequency band from approximately 130 Hz to approximately 300 Hz. The sound pressure gradually increases from approximately 300 Hz so that there is a peak in the frequency band from approximately 1600 Hz to 2000 Hz. In the frequency band higher than the frequency at which the sound pressure has a peak, the sound pressure decrease through to approximately 20000 Hz. Further, a convex roll appears in the frequency band between approximately 50 Hz and approximately 800 Hz. It can be seen that the convex roll is smaller compared to those shown in FIGS. 6, 8.

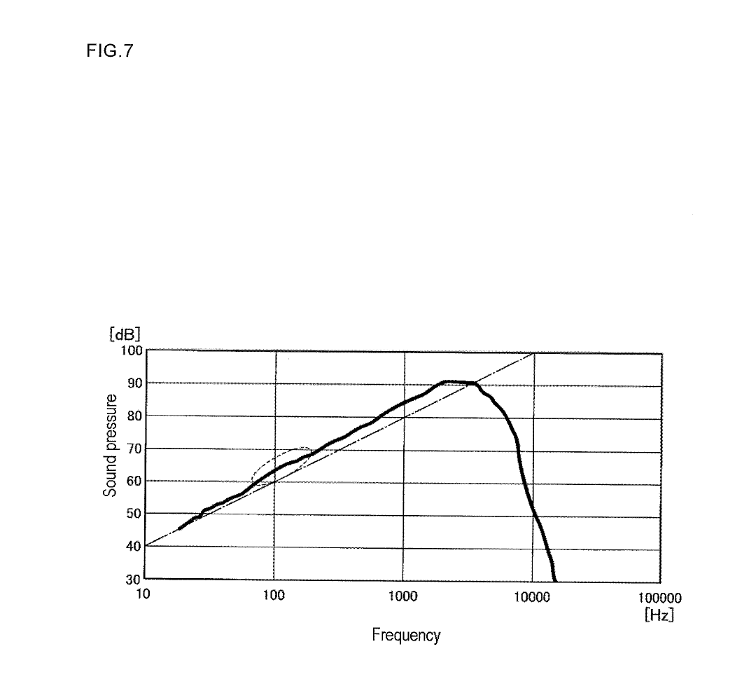

FIG. 6 shows frequency characteristics of output sound pressure when the mode corresponding to the second band pass filter is selected. In the example shown in the drawing, the sound pressure gradually increases from approximately 20 Hz to approximately 1600 Hz. The frequency characteristics of output sound pressure is mountain shaped in the frequency band from approximately 100 Hz to approximately 500 Hz. The frequency characteristics of output sound pressure is flat in the frequency band from approximately 1600 Hz to approximately 4000 Hz. In the frequency band from approximately 4000 Hz to approximately 20000 Hz, the sound pressure gradually decreases. Further, a convex roll appears in the frequency band between approximately 50 Hz and approximately 800 Hz. It can be seen that the convex roll is larger compared to those shown in FIGS. 7, 5 described later.

FIG. 7 shows frequency characteristics of output sound pressure when the mode corresponding to the third band pass filter is selected. In the example shown in the drawing, the sound pressure gradually increases from approximately 20 Hz to approximately 4000 Hz. The mountain-shaped portion in FIG. 6 which appears in the frequency band from approximately 130 Hz to approximately 300 Hz cannot be seen in FIG. 7. The sound pressure gradually decreases in the frequency band from approximately 4000 Hz to approximately 20000 Hz. Further, a convex roll appears in the frequency band between approximately 50 Hz and approximately 800 Hz. It can be seen that the convex roll is smaller compared to those shown in FIGS. 8, 5 described later.

FIG. 8 shows frequency characteristics of output sound pressure when the mode corresponding to the fourth band pass filter is selected. In the example shown in the drawing, the sound pressure gradually increases from approximately 20 Hz to approximately 63 Hz. The rate of increase in sound pressure dramatically increases in the frequency band from approximately 63 Hz to approximately 125 Hz The frequency characteristics of output sound pressure is flat in the frequency band from approximately 125 Hz to approximately 1000 Hz. The sound pressure gradually increases from approximately 1000 Hz to approximately 4000 Hz. The sound pressure gradually decreases in the frequency band from approximately 4000 Hz to approximately 20000 Hz. Further, a convex roll appears in the frequency band between approximately 50 Hz and approximately 800 Hz. It can be seen that the convex roll is greater compared to those shown in FIGS. 5, 7.

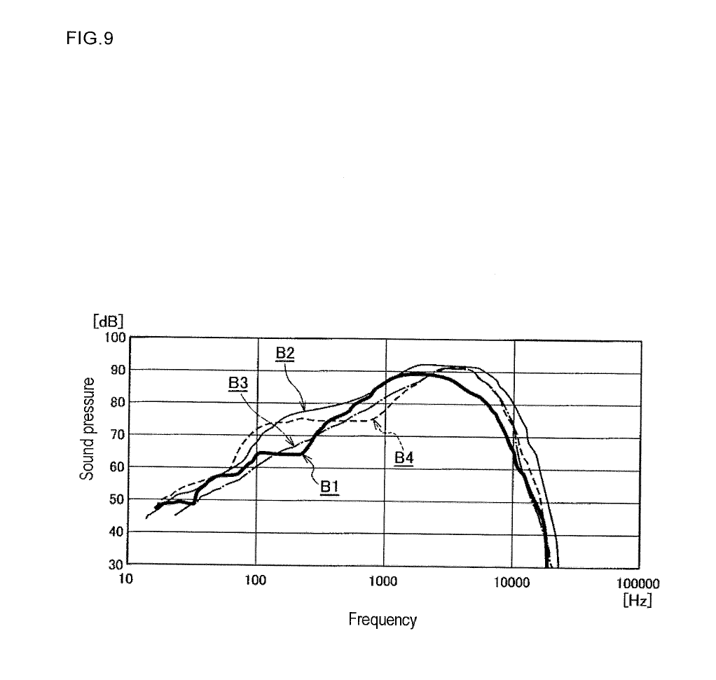

FIG. 9 shows a schematic view illustrating the frequency characteristics of output sound pressure corresponding to each mode described above. The line B1 shows the frequency characteristics of output sound pressure when the first band pass filter is selected. It can be seen from the line B1 that the speaker unit outputs processed sounds with approximately 1000 Hz as a central frequency that is a principal frequency of sounds by selecting the mode corresponding to the first band pass filter. It is possible to determine on the basis of the size in the convex rolls whether or not human voice sounds, TV sounds, or music sounds has increased amplification factors.

The line B2 shows the frequency characteristics of output sound pressure when the second band pass filter is selected. It can be seen from the line B2 that the speaker unit outputs sounds with lower frequencies to allow the sounds emitted in a meeting and so forth to be clearly heard by selecting the mode corresponding to the second band pass filter.

The line B3 shows the frequency characteristics of output sound pressure when the third band pass filter is selected. It can be seen from the line B3 that a user can effectively hear necessary sounds in the normal use environment of daily life and so forth by selecting the mode corresponding to the third band pass filter.

The line B4 shows the frequency characteristics of output sound pressure when the fourth band pass filter is selected. It can be seen from the line B4 that a user can hear sounds with lower frequencies than in a case where the mode corresponding to the second band pass filter is selected by selecting the mode corresponding to the fourth band pass filter. As such, the fourth band pass filter corresponds to TV sounds (approximately 5 Hz to approximately 15 kHz) and the frequency range of music (50 Hz to 15 kHz), and thus makes it possible to watch a TV and hear music suitably.

The plurality of different band pass filters 34A to 34D can be changed over by operating the mode changeover switch 41 as described above. At this moment, the operation unit 40 outputs an operation signal which sequentially switches the plurality of different band pass filters 34A to 34D, for example, each time the mode changeover switch 41 is pressed.

By way of example, the main unit 3 includes a changeover display unit 45 as shown in FIG. 3. The changeover display unit 45 outputs a display signal such that the first light source 4C provides different light emission colors corresponding to each of the plurality of different band pass filters 34A to 34D changed over by the mode changeover switch 41. Thereby, a user can visually recognize the currently set mode of use environment by seeing the light emission color of the first light source 4C provided on the housing 4 of the main unit 3.

The mode changeover switch 41 includes a normal changeover operation for sequentially switching the plurality of different band pass filters 34A, 34B, 34C, 34D. For example, when the changeover switch 41 is pressed one time, if the currently set band pass filter 34 is the first band pass filter 34A, the first band pass filter 34A is replaced by any one of the second band pass filter 34B, the third band pass filter 34C and the fourth band pass filter 34D. Additionally, although the changeover of the plurality of different band pass filters 34A, 34B, 34C, and 34D is performed in that order, the order of changeover may be changed into the order of, for example, 34B, 34A, 34C, and 34D.

Further, the mode changeover switch 41 includes a specific changeover operation to change a band pass filter directly to the first band pass filter 34A from one of the second band pass filter 34B, the third band pass filter 34C, and the fourth band pass filter 34D. For example, when pressing the mode changeover switch 41 consecutively twice or for a long time, the currently set band pass filter 34 is switched to the first band pass filter 34A even if the currently set band pass filter 34 is any one of the second band pass filter 34B, the third band pass filter 34C, and the fourth band pass filter 34D. The specific changeover operation allows the currently set mode to be replaced by the mode for telephone use environment (telephone mode: mode corresponding to the first band pass filter) by one time operation or a series of operation, and thus even when there is a sudden telephone call, a user can quickly change the current mode to the mode for telephone use environment upon receiving the telephone call. Additionally, the current mode may be switched to the mode for telephone use environment when a sensor such as an infrared sensor provided on the earphone 2 detects a telephone receiver approaching to the earphone 2. In this case, a user can switch a mode without pressing the changeover button, and thus usability can be improved.

Further, the main unit 3 includes a changeover notification unit 44 associated with the operation of the mode changeover switch 41 as shown in FIG. 3 by way of example. The changeover notification unit 44 notifies a user of an increase or decrease in the sound volume of an audio signal output to the speaker unit 24 in relation to the changeover of the mode changeover switch 41. Specifically, the changeover notification unit 44 temporally interrupts an audio signal that is processed (including amplification or attenuation) in the audio signal processing circuit 30 and output to the speaker unit 24 during changeover period of the band pass filters 34 using the changeover switch 41. Additionally, the main unit 3 outputs a notification sound through the speaker unit 24. In this way, when switching a mode in accordance with use environment, a user can recognize in advance that the sound volume output through the speaker unit 24 will be increased or decreased. Particularly, a user can be prevented from feeling uncomfortable with a sudden increase in sound volume.

Connection Terminal/Terminal To Be Connected

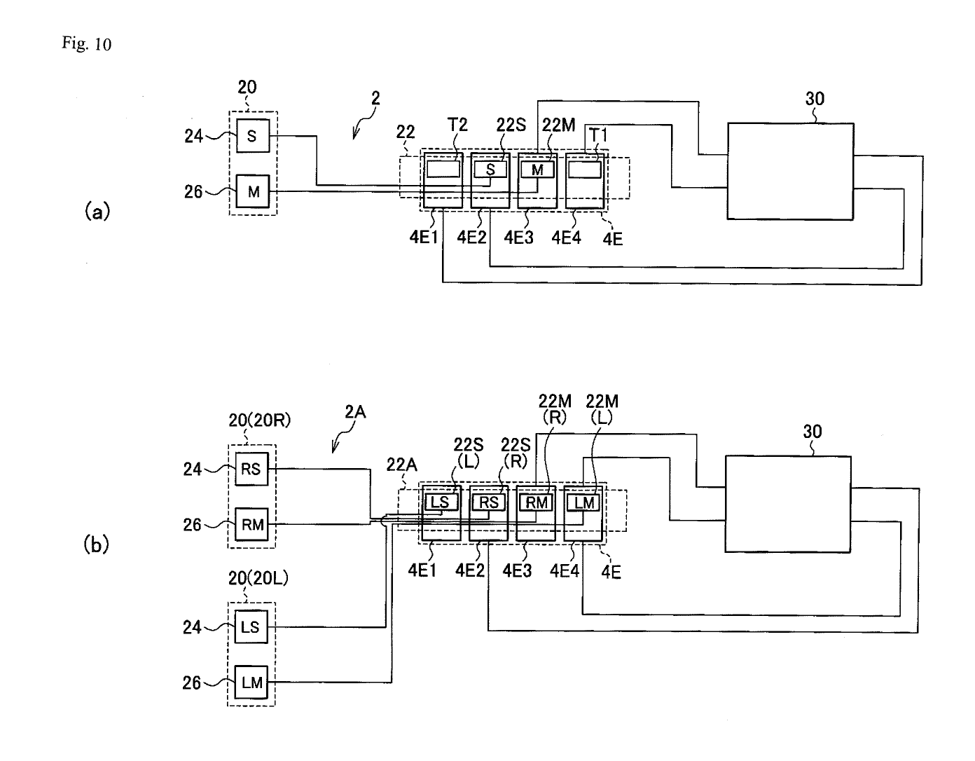

FIG. 10 is a view illustrating the configuration of the connection terminal of the earphone and the terminal to be connected of the main unit. FIG. 10(a) shows a state where the earphone 2 (first earphone) is connected to the main unit 3, and FIG. 10(b) shows a state where the attached earphone 2A (second earphone) is connected to the main unit 3.

The earphone 2 has a single housing 20 in which one speaker unit 24 and one microphone 26 are stored, and the connection terminal 22 includes a microphone terminal 22M and a speaker terminal 22S. Further, the connection terminal 22 includes non-connection terminals T1, T2 which are not connected to the speaker unit and the microphone. Meanwhile, the attached earphone 2A includes two housings (right ear housing 20R and left ear housing 20L), each of which includes one speaker unit 24 and one microphone 26 stored therein. The connection terminal 22A includes a right ear microphone terminal 22M(R) and speaker terminal 22S(R), and a left ear microphone terminal 22M(L) and speaker terminal 22S(L).

Whereas, the terminal to be connected 4E of the main unit 3 includes speaker output terminals (speaker terminals to be connected) 4E1, 4E2, and microphone input terminals (microphone terminals to be connected) 4E3, 4E4. When the connection terminal 22 of the earphone 2 including a single housing 20 is connected to the terminal to be connected 4E, one of the speaker output terminals 4E1, 4E2 (speaker output terminal 4E2 in the example shown in the drawing) is connected to the speaker terminal 22S, and one of the microphone input terminals 4E3, 4E4 (microphone input terminal 4E3 in the example shown in the drawing) is connected to the microphone terminal 22M. Further, the other of the output terminals 4E1, 4E2 (speaker output terminal 4E1 in the example shown in the drawing) is connected to the non-connection terminal T2, and the other of the microphone input terminals 4E3, 4E4 (microphone input terminal 4E3 in the example shown in the drawing) is connected to the non-connection terminal T1.

When the connection terminal 22A of the attached earphone 2A is connected to the terminal to be connected 4E, the microphone terminals 22M(R), 22M(L) of the connection terminal 22A are respectively connected to the microphone input terminals (microphone terminal to be connected) 4E3, 4E4, and the speaker terminals 22S(R), 22S(L) of the connection terminal 22A are respectively connected to the speaker output terminals (speaker terminals to be connected) 4E2, 4E1 of the terminal to be connected 4E.

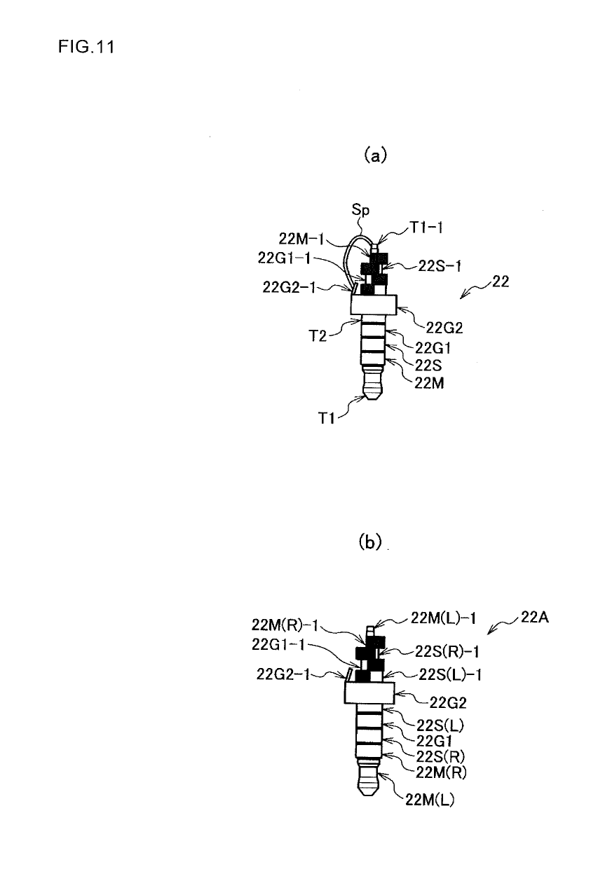

FIG. 11 is a view illustrating a specific example of the connection terminal of the earphone and the attached earphone. FIG. 11(a) shows a specific configuration example of the connection terminal 22 of the earphone 2, and 11(b) shows a specific configuration example of the connection terminal 22A of the attached earphone 2A. As shown in the drawing, both the connection terminal 22 of the earphone 2 and the connection terminal 22A of the attached earphone 2A have a pin-like shape, and have substantially the same shape in terms of the outer appearance and the size in terminal diameter and so forth, each of which is configured to be connected to the terminal to be connected 4E of the main unit 3.

The connection terminal 22A of the attached earphone 2A has six terminals, which are speaker terminals 22S(R), 22S(L), microphone terminals 22SM(R), 22M(L), a speaker ground terminal 22G1 to be grounded, and a microphone ground terminal 22G2. These terminals are respectively arranged near the tip end of the connecting terminal 22A and near the cord 21 with the microphone ground terminal 22G2 as a boundary. That is, the speaker terminals 22S(R), 22S(L) near the tip end of the connection terminal 22A are electrically connected with the speaker terminal 22S(R)-1, 22S(L)-1 near the cord 21, respectively. Similarly, the microphone terminals 22M(R), 22M(L) near the tip end of the connection terminal 22A are electrically connected with the microphone terminal 22M(R)-1, 22M(L)-1 near the cord 21, respectively.

Whereas, the connection terminal 22 of the earphone 2 has the same terminal structure, and includes the speaker terminal 22S corresponding to one speaker unit, the microphone terminal 22M corresponding to one microphone, and two terminals (non-connection terminals T1, T2) which are not connected to the single speaker unit and the single microphone. The non-connection terminals T1, T2 correspond to the microphone terminal 22M(L) and the speaker terminal 22S(L), however, the non-connection terminals T1, T2 are not connected to the speaker unit and the microphone.

Further, the connection terminal 22 has the speaker ground terminal 22G1 and the microphone ground terminal 22G2 as with the connection terminal 22A. The speaker terminal 22S near the tip end of the connection terminal 22 is electrically connected with the speaker terminal 22S-1 near the cord 21, and the microphone terminal 22M near the tip end is electrically connected with the microphone terminal 22M-1 near the cord 21.

The non-connection terminal T1-1 near the cord is electrically connected with the microphone ground terminal 22G2-1 near the cord through a wire Sp (conductive wire and so forth).

Thereby, the non-connection terminal T1 and the microphone ground terminal 22G2 are electrically connected each other so that the non-connection terminal T1 is short-circuited (grounded). In the example shown in the drawing, although the non-connection terminal T1 is short-circuited, the non-connection terminal T2 may be short-circuited.

The control tool 50 (example: microcomputer) provided in the main unit 3 detects the short-circuiting, and thereby detects that the earphone 2 is connected to the main unit 3. At that moment, the control tool 50 controls the sound pressure balance adjustment unit 39 which adjusts the sound pressure balance of the audio signal output to the right and left speaker output terminals 4E1, 4E2, and turns the adjustment function of the sound pressure balance off (suspension).

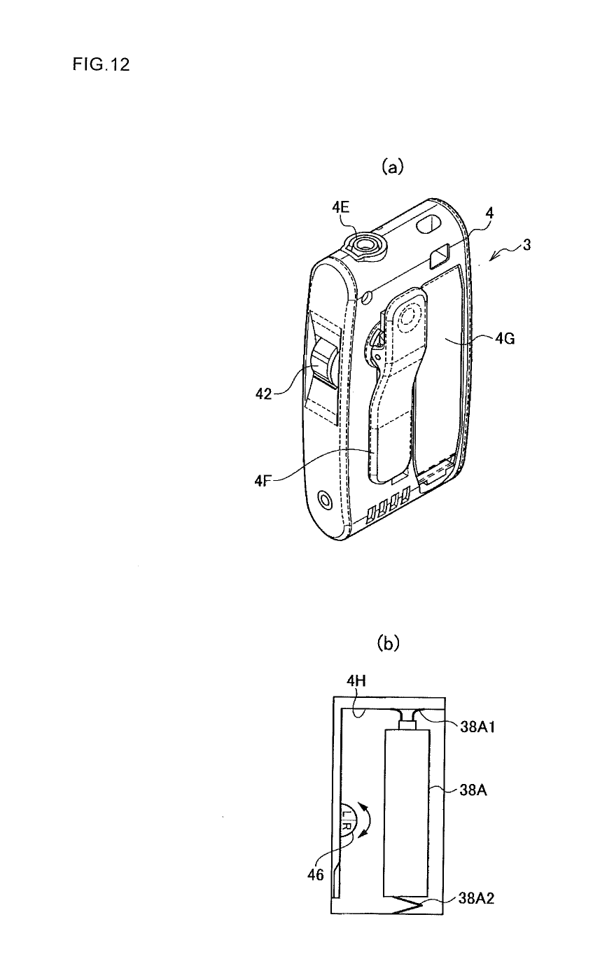

FIG. 12 is a view illustrating the main unit of the audio processing device according to an embodiment of the present invention. FIG. 12(a) shows the configuration on the rear face, and FIG. 12(b) shows a battery insertion part of the main unit. As shown in the drawing, the main unit 3 has a holding clip 4F for holding the main unit 3 on clothes and so forth provided on the rear side of the main unit 3. Further, the main unit 3 includes a battery insertion part 4H where a battery or a rechargeable battery can be inserted. The battery insertion part 4H is covered with a lid 4G. When the lid 4G is opened, a battery 38A, positive and negative terminals 38A1, 38A2 electrically connected to the battery 38A, and the wheel-shaped sound pressure balance adjustment operation unit 46 can be seen in the battery insertion part 4H as shown in FIG. 12(b), the sound pressure balance adjustment operation unit 46 located at a position which allows a user to adjust the sound pressure balance, for example, by hand.

The sound pressure balance adjustment operation unit 46 sends an adjustment signal to the sound pressure balance adjustment unit 39 to adjust the output sound balance between one speaker unit and the other speaker unit of the two speaker units provided in the earphone 2A. By adjusting the sound pressure balance adjustment operation unit 46, it is possible to increase the volume of the sound emitted from one speaker unit while reducing the volume of the sound emitted from the other speaker unit. Also, it is possible to output the sound only from one speaker unit of the two speaker units by adjusting the sound pressure balance adjustment operation unit 46 to maximize the output from the one speaker unit. Specifically, it is possible to increase or decrease the volume of the sound output from one and the other speaker units, for example, by changing the value of a variable resistor provided in the sound pressure balance adjustment unit 39 in accordance with the adjustment state of the sound pressure balance adjustment operation unit 46. Also, although the previous description shows an example of the sound pressure balance adjustment in the sound pressure balance adjustment unit 39 done by adjusting the value of a variable resistor, the sound pressure balance adjustment may be done through digital signal processing using a digital signal processor (DSP) instead of the use of the variable resistor.

As previously described, the sound pressure balance adjustment unit 39 turns the balance adjustment function on (operation) or off (suspension) on the basis of the adjustment signal from the control tool 50. That is, the main unit 3 can suspend the adjustment by the sound pressure balance adjustment operation unit 46 for the audio signal output from the audio signal processing circuit 30 to the speaker unit of the first earphone (earphone 2). The detailed operation is described below:

The sound pressure balance adjustment unit 39 provided in the main unit 3 has a right ear adjustment circuit which adjusts the audio signal collected by the microphone in the right ear housing 20R to output the adjusted audio signal to the speaker unit in the housing 20R, and a left ear adjustment circuit which adjusts the audio signal collected by the microphone in the left ear housing 20L to output the adjusted audio signal to the speaker unit in the housing 20L in order to correspond to the attached earphone 2A including the housing 20R attached to the right ear of a user and the housing 20L attached to the left ear. The sound pressure balance adjustment unit 39 is designed such that when the earphone 2 including one speaker unit and one microphone is connected to the main unit 3, the sound pressure balance adjustment unit 39 selects one of the above-described right ear adjustment circuit and left ear adjustment circuit, and the audio signal collected by the microphone in the earphone 2 is input into, for example, only the right ear adjustment circuit.

At this moment, it can be assumed that a user using the attached earphone 2A connected to the main unit 3 operates the sound pressure balance adjustment operation unit 46 to allow the sound to be output only from the left ear speaker unit (the sound is adjusted not to be output from the right ear speaker unit). In this case, when the earphone 2 having one speaker unit and one microphone stored in a single housing is connected to the main unit 3, the audio signal is input to only the right ear adjustment circuit. However, if the sound pressure balance adjustment unit 39 is activated at that moment, the right ear adjustment circuit does not output a signal, thereby resulting in a state where sound cannot be heard from the speaker unit of the earphone 2, and thus a user may misunderstand that the main unit has some defect.

In an embodiment according to the preset invention, when the control tool 50 detects that the earphone 2 having one speaker unit and one microphone stored in the single housing is connected to the main unit 3, the control tool 50 sends an adjustment signal to the sound pressure balance adjustment unit 39 to turn the adjustment function of the sound pressure balance adjustment unit 39 off (suspension).

As such, when the earphone 2 is connected to the main unit 3 and an audio signal is input only to either the right ear or the left ear adjustment circuit, no matter how the sound pressure balance adjustment operation unit 46 is operated, the audio signal is always output to the speaker unit of the earphone 2. Thereby, the problem that no sound is output from the speaker unit when the earphone 2 is connected to the main unit 3 can be eliminated.

Further, when the control tool 50 detects that the earphone 2 having one speaker unit and one microphone stored in the single housing is connected to the main unit 3, the control tool 50 sends a signal to the sound pressure balance adjustment unit 39 to turn the adjustment function of the sound pressure balance adjustment unit 39 off (suspension), and thereby eliminated the problem that no sound is output from the speaker unit when the earphone 2 is connected to the main unit 3. Further, the audio processing device 1 is configured to detect that the earphone 2A is connected to the main unit 3, and when the control tool 50 detects that the earphone 2A is connected to the main unit 3, the control tool 50 sends a signal to the sound pressure balance adjustment unit 39 to turn the adjustment function of the sound pressure balance adjustment unit 39 on (operation). Thereby, the sound pressure balance adjustment function when the earphone 2A is connected to the main unit 3 is restored.

Here, if the adjustment function of the sound pressure balance adjustment unit 39 is turned off, an audio signal is output to the speaker unit without being subjected to sound pressure adjustment. Methods for achieving such a controlling operation may include: setting the signal path of an audio signal to bypass the sound pressure balance adjustment unit 39; and skipping a digital processing step for the audio signal performed by the sound pressure balance adjustment unit 39. However, any method may be employed as the actual method.

When the connection terminal 22A of the attached earphone 2A equipped with two housings 20 is connected to the terminal to be connected 4E, the microphone terminals 22M(R), 22M(L) are respectively connected to the microphone input terminals 4E3, 4E4 of the terminal to be connected 4E, and the speaker terminals 22S(R), 22S(L) are respectively connected to the speaker output terminals 4E2, 4E1 of the terminal to be connected 4E. The audio signal output from the audio signal processing circuit 30 to the speaker output terminals 4E2, 4E1 may be a monaural signal or a stereo signal. When the audio signal is a stereo signal, the audio signal generated by processing (including amplification or attenuation) the audio signal input into the microphone terminal 22M (R) is output to the speaker output terminal 4E2, and the audio signal generated by processing (including amplification or attenuation) the audio signal input into the microphone terminal 22M (L) is output to the speaker output terminal 4E2.

Although embodiments according to the present invention are described with reference to the drawings, the specific configuration is not limited to these embodiments, and the design alterations not departing from the scope of the present invention are included in the present invention. In addition, the embodiments described above may be combined each other by mutually using the techniques as long as there is neither contradiction nor problem in the purpose, configuration and so forth.

1.-22. (canceled)

23. An audio processing device comprising:
an earphone including a microphone, a cord, and a cord holding part; and
a main unit connected to the cord, wherein
the main unit processes an audio signal sent from the microphone;
the earphone includes a housing storing the microphone;
the housing includes a microphone hole part; and
the cord holding part faces the microphone hole part.

24. The audio processing device according to claim 23, wherein the earphone includes a speaker unit.

25. The audio processing device according to claim 23, wherein
the main unit comprises an audio signal processing circuit that processes amplification or attenuation of the audio signal;
the cord sends the audio signal from the microphone to the audio signal processing circuit;
the cord holding part is formed with a member having greater bending rigidity than the cord; and
the microphone hole part allows an internal space of the housing and outside of the housing to communicate with each other.

26. The audio processing device according to claim 23, wherein
the cord is formed with a conductive wire and an insulation member insulating a conductive wire from outside; and
the cord holding part is formed with a member having greater bending rigidity than the insulation member.

27. The audio processing device comprising:
a microphone;
a main unit that processes an audio signal sent from the microphone;
a signal line connecting the microphone and the main unit, and
a housing part storing the microphone; wherein
the housing part includes a hole part, and
the signal line is covered with a resin member and faces the hole part.

28. The audio processing device according to claim 27, wherein a speaker unit is stored in the housing part.

29. The audio processing device according to claim 27, wherein
the main unit includes an audio signal processing circuit that processes amplification or attenuation of the audio signal;
the signal line sends the audio signal from the microphone to the audio signal processing circuit; and
the hole part allows an internal space of the housing part and outside of the housing part to communicate with each other.

30. A earphone comprising: a microphone; a cord holding part; and a housing storing the microphone, wherein
the cord holding part faces a microphone hole part of the housing.

31. The earphone according to claim 30, wherein a speaker unit is stored in the housing.

32. The earphone according to claim 30, comprising a cord;
the cord holding part is formed with a member having greater bending rigidity than the cord; and
the microphone hole part allows an internal space of the housing and outside of the housing to communicate with each other.

33. The earphone according to claim 32, wherein
the cord is formed with a conductive wire and an insulation member insulating a conductive wire from outside; and
the cord holding part is formed with a member having greater bending rigidity than the insulation member.

34. A earphone comprising: a microphone; a signal line; and a housing storing the microphone, wherein
the signal line is covered with a resin member and faces a hole part of the housing.

35. The earphone according to claim 34, wherein a speaker unit is stored in the housing.

36. The earphone according to claim 34, wherein the hole part allows an internal space of the housing and outside of the housing to communicate with each other.
